(19) United States
(12) Patent Application Publication
(10) Pub. No.: US 2018/0202792 A1
(43) Pub. Date: Jul. 19, 2018

(54) SENSING DEVICE AND SENSING SYSTEM

(71) Applicant: Panasonic Intellectual Property Management Co., Ltd., Osaka (JP)

(72) Inventors: Taichi HAMABE, Osaka (JP); Tatsuhiko NUMOTO, Osaka (JP); Akihiro TATSUTA, Kyoto (JP)

(21) Appl. No.: 15/923,162

(22) Filed: Mar. 16, 2018

Related U.S. Application Data
(63) Continuation of application No. PCT/JP2016/004349, filed on Sep. 27, 2016.

(30) Foreign Application Priority Data
Sep. 30, 2015 (JP) 2015-192388

(51) Int. Cl. G01B 7/02; G01V 3/38

(52) U.S. Cl. CPC G01B 7/02; B64D 11/003; G01V 3/38

(57) ABSTRACT

Sensing device (2) is to be mounted in a storage unit. Sensing device (2) includes: a plurality of sensors (4) to be provided on a predetermined surface of the storage unit; a determiner that determines an inner state of the storage unit, based on sensing results of the plurality of sensors (4); and a report unit that reports a determination result of the determiner.

### BACKGROUND

### 1. Technical Field

The present disclosure relates to a sensing device that senses an object inside a storage unit and to a sensing system equipped with this sensing device.

### 2. Description of the Related Art

PTL 1 discloses a sensing device that makes it possible to externally check whether an object is contained in a storage unit such as a locker.

### CITATION LIST

### Patent Literature

PTL 1: Unexamined Japanese Patent Publication No. 2009-193327

### SUMMARY

The present disclosure provides a sensing device that makes it possible to check an inner state of a storage unit with a simple configuration.

A sensing device of the present disclosure is to be mounted in a storage unit. The sensing device includes: a plurality of sensors to be provided on a predetermined surface in the storage unit; a determiner that determines an inner state of the storage unit, based on sensing results of the plurality of sensors; and a report unit that reports a determination result of the determiner.

A sensing device of the present disclosure makes it possible to check an inner state of a storage unit with a simple configuration.

### BRIEF DESCRIPTION OF DRAWINGS

FIG. 1A is a view of a storage unit in which a sensing device in an exemplary embodiment of the present disclosure is mounted;

FIG. 1B is another view of the storage unit in which the sensing device in the exemplary embodiment is mounted;

FIG. 2 illustrates a layout of sensors in the exemplary embodiment;

FIG. 3 is a block diagram of a sensing system in the exemplary embodiment;

FIG. 4 is a conceptual view of a method of sensing baggage in the exemplary embodiment; and

FIG. 5 is another conceptual view of the method of sensing baggage in the exemplary embodiment.

### DETAILED DESCRIPTION

Some exemplary embodiments of the present disclosure will be described below in detail with reference to the accompanying drawings as appropriate. In some instances, excessively detailed descriptions will be omitted. For example, detailed descriptions of known subjects or repetitive descriptions of substantially identical configurations may be omitted. These omissions aim to avoid making the following description unnecessarily redundant, helping an understanding of those skilled in the art.

It should be noted that the accompanying drawings and the following descriptions are provided for those skilled in the art to fully understand the present disclosure, and are not intended to limit the subject matters described in the claims.

### Exemplary Embodiment

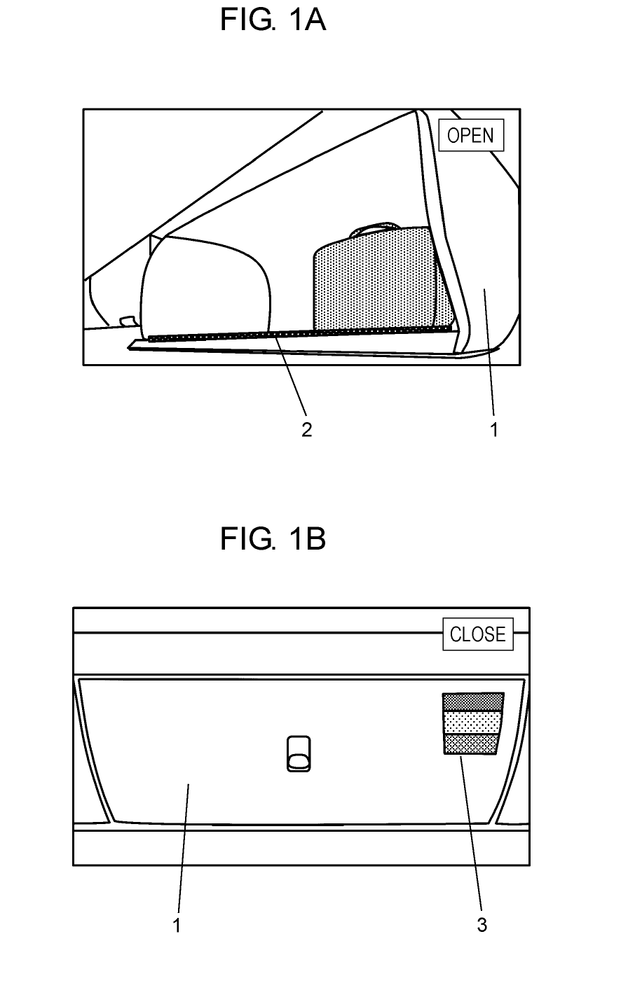

An exemplary embodiment will be described below with reference to FIGS. 1A to 5.

First, a sensing device in the present exemplary embodiment will be described with reference to FIGS. 1A and 1B. In this exemplary embodiment, as an example, the sensing device is mounted in a storage unit, such as a baggage rack, above each seat of an aircraft.

FIGS. 1A and 1B each illustrate storage unit 1 in which sensing device 2 in the exemplary embodiment is mounted. In FIG. 1A, a door of storage unit 1 is open, whereas in FIG. 1B, the door is closed.

As illustrated in FIG. 1A, sensing device 2 is mounted on a lower inner surface in storage unit 1; the lower inner surface corresponds to a predetermined surface herein. For example, a plurality of storage units 1 are provided in the aircraft, and each storage unit 1 can accommodate baggage, such as objects. Sensing device 2 can sense whether baggage is placed on the lower inner surface of storage unit 1. A main body of sensing device 2 does not necessarily have to be mounted in storage unit 1. Alternatively, only sensors 4 of sensing device 2 may be mounted in storage unit 1, as will be described later.

When the door of storage unit 1 is closed as illustrated in FIG. 1B, nobody can see baggage inside storage unit 1 and thus it may be difficult to realize an inner state of storage unit 1. For this reason, storage unit 1 is provided with display device 3 on its exterior, as illustrated in FIG. 1B. Display device 3 allows flight attendants and passengers in an aircraft to visually check the inner state of storage unit 1 even with the door closed. This means that the flight attendants and passengers can realize the inner state of storage unit 1 without having to open the door. Specifically, for example, display device 3 displays the amount of space, a number of pieces of baggage, and their sizes inside storage unit 1 in the form of visual information using scale marks, characters, or number.

Display device 3 is preferably implemented using a low-power device, such as an electronic paper or a liquid crystal memory. In this exemplary embodiment, display device 3 may be the electronic paper.

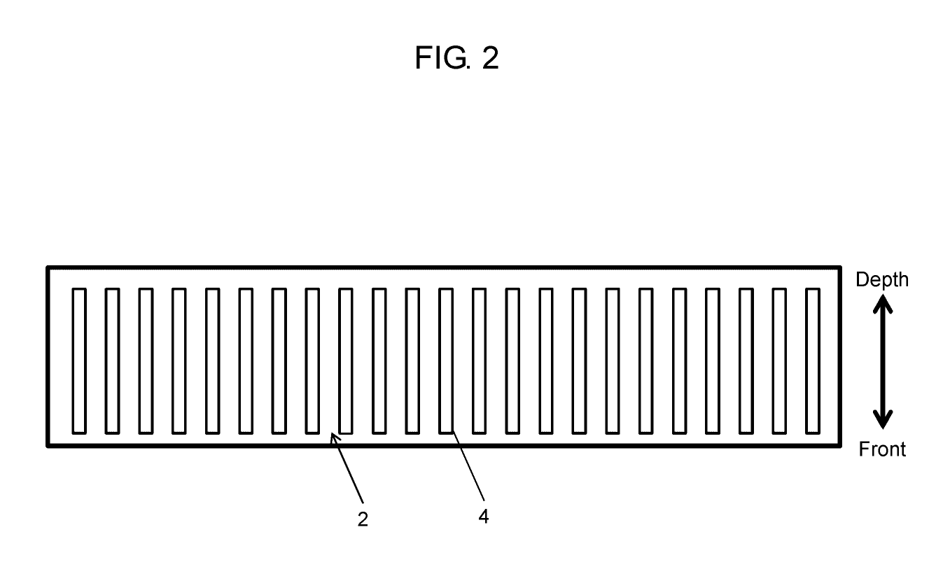

Next, a layout of sensors 4 in sensing device 2 will be described with reference to FIG. 2. FIG. 2 illustrates the layout of sensors 4 in the exemplary embodiment.

As illustrated in FIG. 2, each of sensing device 2 and sensors 4 is formed into a rectangular or elongated sheet. The plurality of sensors 4 are disposed at equal intervals on an elongated surface of sensing device 2. More specifically, sensors 4 are disposed side by side along a longer side of the elongated surface of sensing device 2. In this case, a shorter side of sensors 4 is substantially parallel to the longer side of sensing device 2. In this exemplary embodiment, a length of each sensor 4 on the shorter side may be set to 20 mm, and the interval between sensors 4 may be set to 100 mm.

The reason why the plurality of sensors 4 are disposed as FIG. 2 is to accurately determine a state of baggage inside storage unit 1. If single sensor 4 is disposed so as to cover the entire lower inner surface of storage unit 1, for example, sensor 4 provides only one output. Using the one output, it may be difficult to accurately determine, for example, how many pieces of baggage are placed inside storage unit 1 or how much size baggage has.

Furthermore, the reason why the longer side of each sensor 4 is substantially parallel to a shorter side of the predetermined surface of storage unit 1 is to sense baggage along the longer side of storage unit 1 more accurately than along the shorter side of storage unit 1. In general, the passengers place their baggage side by side on the predetermined surface along its longer side. As a result, only one piece of baggage is placed along the shorter side. For this reason, only one sensor 4 is disposed on the predetermined surface along the shorter side of the predetermined surface, but a number of sensors 4 are disposed along the longer side of the predetermined surface.

Each sensor 4 may be implemented using a pressure-sensitive resistor such as a pressure-sensitive, conductive rubber. When baggage is placed on sensor 4, sensor 4 bears a load and is thereby compressed. As a result, a resistance of sensor 4 decreases. Sensing device 2 measures the variation in the resistance, thereby sensing the presence of the baggage.

In addition, any protective member may be provided on sensors 4 mounted on the lower inner surface of storage unit 1 where baggage is to be placed. Providing the protective member can protect sensors 4 and reduce unevenness of the lower inner surface which may be caused as a result of disposing sensors 4, which enables baggage to be placed on the flat surface.

For example, the protective member may be resin filled in gaps between sensors 4 or may be a flat plate bonded to the lower inner surface so as to cover the plurality of sensors 4. If the flat plate is used as the protective member, additional members having substantially same thickness as sensors 4 are preferably provided in the gaps between sensors 4 so as to support the protective member from the bottom. Providing the additional member in this manner can suppress sensor 4 from being damaged due to a load or shock given by the baggage, for example.

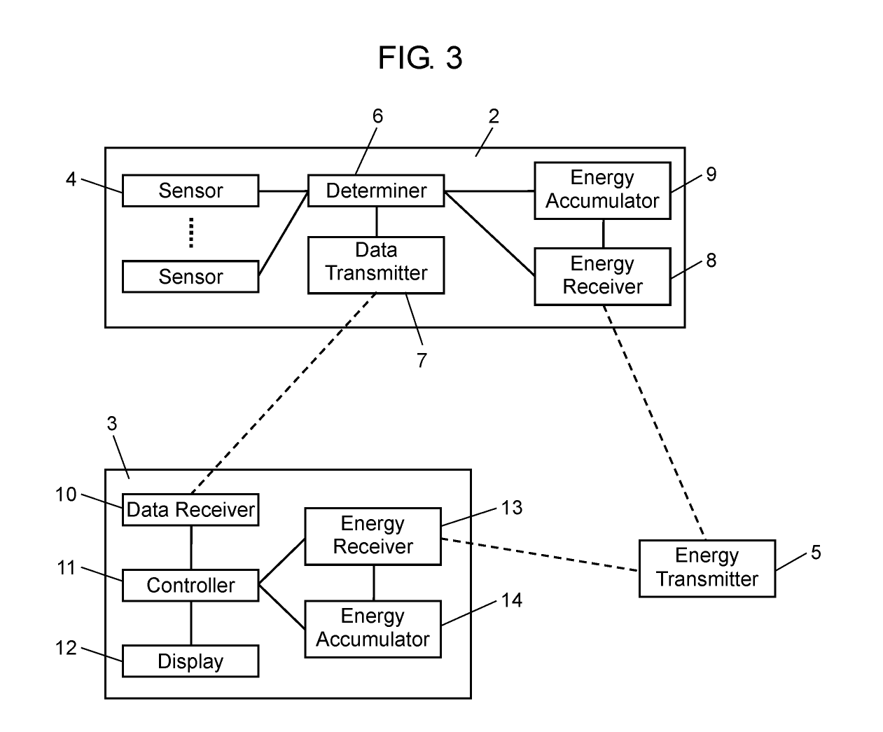

Next, a sensing system provided with sensing device 2 will be described with reference to FIG. 3. FIG. 3 is a block diagram of the sensing system in the exemplary embodiment.

As illustrated in FIG. 3, the sensing system includes, in addition to sensing device 2 and display device 3 described above, energy transmitter 5.

Sensing device 2 includes, in addition to the plurality of sensors 4 described above, determiner 6, data transmitter 7, energy receiver 8, and energy accumulator 9; data transmitter 7 serves as a report unit herein.

Determiner 6 determines the inner state of storage unit 1 based on outputs from the plurality of sensors 4 and then transmits the determination result to data transmitter 7. In addition, determiner 6 acquires electricity required for entire sensing device 2 to operate, from both energy receiver 8 and energy accumulator 9, thereby controlling the electricity.

Data transmitter 7 receives the determination result from determiner 6 and then transmits this determination result to display device 3. This transmission may be performed through wireless communication conforming to Bluetooth (registered trademark), for example. In this exemplary embodiment, data transmitter 7 transmits the determination result to display device 3; however, data transmitter 7 may transmit the determination result to portable devices, such as tablet computers, carried by the flight attendants, or to display device 3 and the portable devices simultaneously.

Energy receiver 8 receives energy from energy transmitter 5 and then converts the form of this energy so that sensing device 2 can operate. More specifically, energy transmitter 5 may correspond to a communication infrastructure in the aircraft and emit a radio wave conforming to, for example, Wireless Fidelity (Wi-Fi) which is available in the aircraft. Energy transmitter 5 basically transmits the radio wave used for communication, but energy receiver 8 converts this radio wave into the electricity used for an operation.

Energy accumulator 9 stores the electricity into which energy receiver 8 has converted the radio wave. Determiner 6 is thereby temporarily supplied with an amount of electricity beyond the conversion capacity of energy receiver 8.

With the above configuration, entire sensing device 2 can operate from the radio wave propagating in the aircraft, in other words, can operate without using any power source.

Display device 3 includes data receiver 10, controller 11, and display 12. In addition, display device 3 further includes energy receiver 13 and energy accumulator 14, similar to sensing device 2. Energy receiver 13 is similar in function to energy receiver 8; likewise, energy accumulator 14 is similar in function to energy accumulator 9.

Data receiver 10 receives data from data transmitter 7 and then forwards the data to controller 11.

When receiving the data from data receiver 10, controller 11 instructs display 12 to display this data in given form. In addition, controller 11 controls the electricity supplied from both energy receiver 8 and energy accumulator 9 in such a way that display device 3 can operate.

Display 12 displays the determination result of sensing device 2.

It should be noted that the sensing system in this exemplary embodiment employs a wireless communication design in terms of its lightweight property and ease of installation. By eliminating use of cables and other connecting members, the sensing system is lightened so as to reduce the risk of affecting the aircraft. In addition, the wireless communication design enables the sensing system to be installed easily in an existing facility without any modifications.

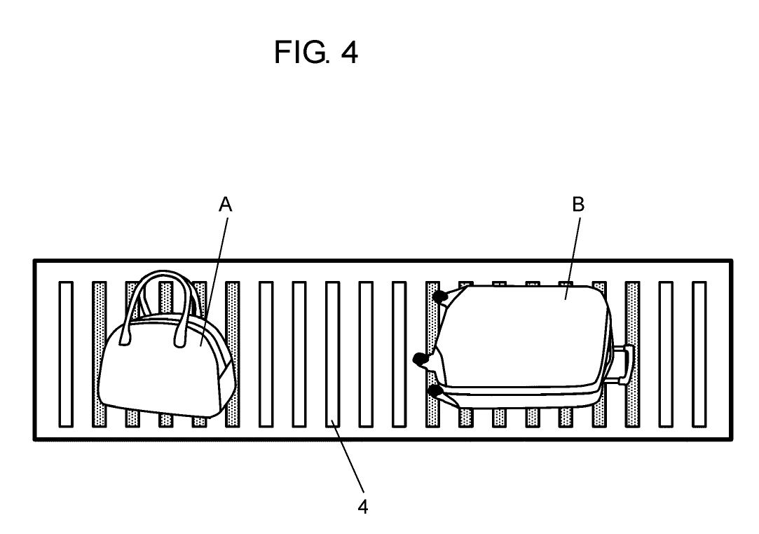

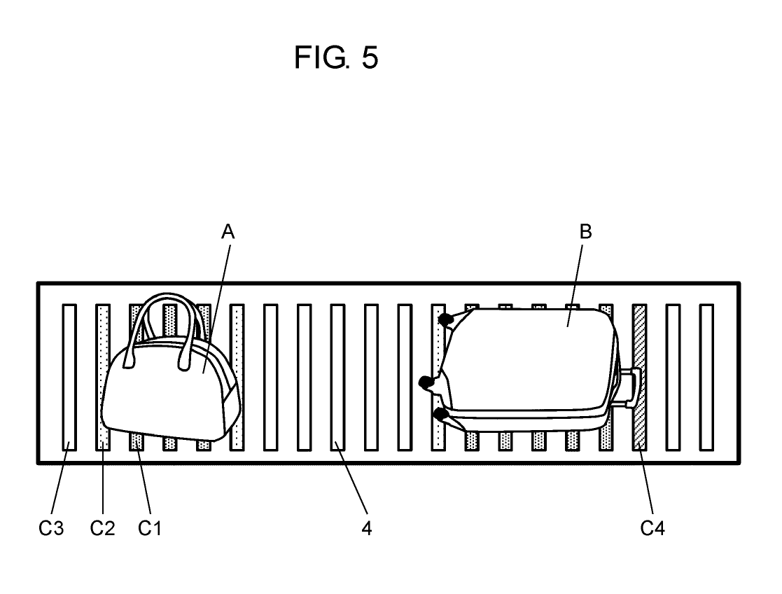

A determination method made by determiner 6 in sensing device 2 will be described below in detail, with reference to FIGS. 4 and 5. FIGS. 4 and 5 are conceptual views of a method of sensing baggage in the exemplary embodiment.

The determination method in this exemplary embodiment will be described using two specific examples; a first determination method and a second determination method. However, the determination method in this exemplary embodiment is not limited to the first and second determination methods.

First, the first determination method will be described. This first determination method is used to determine the amount of space in storage unit 1.

As illustrated in FIG. 4, for example, storage unit 1 is expected to accommodate pieces of baggage A and B. In this example, when the pieces of baggage A and B are placed in certain areas on the lower inner surface, these areas bear loads. As a result, sensors 4 in the areas indicate a lower resistance than a resistance of sensors 4 in other areas. Determiner 6 regards this difference between resistances of sensors 4 as a resistance variation output from sensors 4. More specifically, the resistance variation of sensor 4 can be measured by determining a voltage (that is a divided voltage value) applied to the pressure-sensitive resistor, while the pressure-sensitive resistor is combined with a fixed resistance.

Here, a method of measuring this divided voltage value will be described below. In this exemplary embodiment, the sensing system employs wireless communication to supply the electricity, and thus preferably can operate with a decreased amount of electricity. In the exemplary embodiment, therefore, voltage measuring circuits are not provided one by one for respective sensors 4. Instead, sensors 4 are divided into some groups, and each of the groups shares a voltage measuring circuit. Each voltage measuring circuit measures the voltages across corresponding sensors 4 in a time division manner. This configuration can be formed with a small number of circuit components, thereby lowering power consumption.

When neither the pieces of baggage A nor B is placed in a certain area on the lower inner surface, this area bears no load. Therefore, the resistance of sensor 4 placed in the area does not vary. As a result, the voltages across these sensors 4 do not vary and thus are normal in value.

In this way, determiner 6 senses both varying and unvarying voltages across sensors 4, thereby making it possible to determine a ratio of a number of sensors 4 on which baggage A or B is placed to a number of sensors 4 on which neither the pieces of baggage A nor B is placed. In FIG. 4, out of twenty sensors 4, twelve indicate varying resistances. In this case, determiner 6 determines that the baggage occupies 60% of the interior of storage unit 1, in other words, 40% of the interior is space.

Second, the second determination method will be described. This second determination method is used to determine the number of pieces of baggage and their sizes.

In consideration of their shapes, in general, both of pieces of baggage A and B place lighter loads at their ends than in their center. Furthermore, since sensors 4 are disposed at intervals, the ends of pieces of baggage A and B are expected to be in contact with some of sensors 4.

In this second determination method, as opposed to the foregoing first determination method, loads on sensors 4, namely, voltages across sensors 4 are not sensed in a binary manner. More specifically, loads on sensors are divided into three groups; an unloaded group, a lightly loaded group, and a heavily loaded group. Dividing sensors 4 into the groups makes it possible to accurately realize the inner state of storage unit 1.

In this case, determiner 6 uses first and second thresholds for the grouping; the first threshold is greater than the second threshold. If the resistance of sensor 4 is equal to or more than the first threshold, determiner 6 determines that this sensor 4 belongs to the unloaded group. If the resistance of sensor 4 is less than the first threshold and equal to or more than the second threshold, determiner 6 determines that this sensor 4 belongs to the lightly loaded group. If the resistance of sensor 4 is less than the second threshold, determiner 6 determines that this sensor 4 belongs to the heavily loaded group.

By repeating this determination, determiner 6 can determine which of the groups sensors 4 belong to. In FIG. 5, sensors 4 belonging to the heavily loaded group are indicated by pattern C1, sensors 4 belonging to the lightly loaded group are indicated by pattern C2; and sensors 4 belonging to the unloaded group are indicated by pattern C3. Thus, sensors 4 indicated by the same pattern in FIG. 5 belong to the same group.

Furthermore, in consideration of the face that both of pieces of baggage A and B place lighter loads at their ends than in their center, determiner 6 identifies an area, in the center of which sensors 4 belonging to the heavily loaded group are present and at the ends of which sensors 4 belonging to the lightly loaded group are present. Then, determiner 6 determines that a single piece of baggage is placed in the identified area.

In this way, determiner 6 can accurately determine the number of pieces of baggage and reports this number to display device 3. Moreover, since sensors 4 are disposed at equal intervals, determiner 6 can also determine a distance between two sensors 4 belonging to the lightly loaded group. This means that determiner 6 can sense sizes of pieces of baggage A and B.

Even if sensors 4 are not disposed at equal intervals, determiner 6 only has to know these intervals in advance. Determiner 6 thereby can sense the sizes of pieces of baggage A and B as in the case where sensors 4 are disposed at equal intervals.

If baggage has a handle like baggage B, the handle may float in the air and thus be in non-contact with sensor 4. In this case, sensor 4, such as sensor 4 indicated by pattern C4 in FIG. 5, might fail to sense the handle even by using the first and second thresholds. As a result, determiner 6 may fail to identify an area at both ends of which sensors 4 belonging to the lightly loaded group are present. However, determiner 6 may designate sensor 4 indicated by pattern C4 as sensor 4 belonging to the lightly loaded group when making the determination.

Furthermore, if adjacent sensors 4 sense any objects at the same time, determiner 6 may determine that the sensed objects are identical. An example of the same time is within one second.

The second determination method also makes it possible to determine whether a load is placed on each sensor 4. Therefore, in the second determination method, determiner 6 may also output the amount of space as the determination result, similar to the first determination method.

Sensors 4 and determiner 6 may continue to perform the above determination methods; however, sensors 4 and determiner 6 preferably perform the determination methods only at a predetermined timing, for example, when the door of storage unit 1 is closed. This operation contributes to low power consumption of the sensing system. The operation is preferred, especially when the electricity is supplied through the wireless communication as in this exemplary embodiment. Display device 3 thereby can display the inner state of storage unit 1 which has been determined before the door is closed.

In this case, display device 3 may reset its operation when the aircraft is maintained, for example. When display device 3 displays no contents, everybody can realize that the determination has not yet made. This operation can be used to check whether the door of storage unit 1 is closed properly.

As described above, it is possible to provide the sensing system that makes it possible to easily check the inner state of storage unit 1 by making the determinations using the plurality of sensors 4.

### Other Exemplary Embodiments

As described above, the exemplary embodiment has been described as an example of the technique disclosed in the present application. However, the technique in the present disclosure is not limited to the foregoing exemplary embodiment, and can also be applied to embodiments in which change, substitution, addition, and omission, for example, are performed. A new exemplary embodiment can also be made by a combination of the components described in the exemplary embodiment.

Accordingly, other exemplary embodiments will be described below.

In the exemplary embodiment, the pressure sensors are used as an example of sensors 4; however, for example, photosensors that sense light or ultrasonic sensors that sense sound may be used instead.

In the exemplary embodiment, sensing device 2 and display device 3 generate electric power from the radio wave propagating in the air; however, for example, sensing device 2 and display device 3 may generate electric power by another electricity supply scheme such as solar power generation.

In the exemplary embodiment, the sensing system includes sensing device 2 and display device 3 in storage unit 1; however, as an alternative example, storage unit 1, sensing device 2, and display device 3 may be configured in an integrated manner.

In the exemplary embodiment, sensors 4 are disposed at equal intervals; however, sensors 4 may be disposed at different intervals. As an alternative example, sensors 4 may be disposed at shorter intervals in the center than at the ends of sensing device 2.

In the exemplary embodiment, the baggage rack above each seat is used as an example of storage unit 1; however, a baggage rack in another place may be used instead. Determiner 6 may further determine whether passengers sit on seats and fasten their seatbelts, and may report this determination result to display device 3. In response, display device 3 may display the determination result in relation to the information regarding storage unit 1. For example, combining the result of the determination whether passengers sit on seats and the information regarding storage unit 1, it is possible to prevent the passengers from forgetting their baggage inside storage unit 1 after the aircraft has arrived.

In the exemplary embodiment, the determination using sensors 4 are made for each storage unit 1; however, the determination may be made for some adjacent storage units 1. In this case, for example, display device 3 may display information on the amounts of spaces of these storage units 1.

In the exemplary embodiment, baggage is used as an example of an object; however, the object is not limited to the baggage. As an alternative example, food may be used instead, in which case the sensing system may be mounted in a refrigerator, for example. The present disclosure is applicable not only to storage units with a door but also, for example, shelves positioned so high that a user cannot check what is placed thereon.

For the present exemplary embodiment described herein only by way of example of the technology according to the present disclosure, various modifications, replacements, additions, omissions or others may be made within the range of the appended claims or an equivalence of this range.

The present disclosure can achieve checking of an inner state of a storage unit with a simple configuration. Therefore, the present disclosure is applicable to not only storage units but also other units, especially including baggage racks in an aircraft, a train, and a bus, for example.

What is claimed is:

1. A sensing device to be mounted in a storage unit, the sensing device comprising:
a plurality of sensors to be provided on a predetermined surface in the storage unit;
a determiner that determines an inner state of the storage unit based on sensing results of the plurality of sensors; and
a report unit that reports a determination result of the determiner.

2. The sensing device according to claim 1, wherein
the predetermined surface has an elongated shape, and
the plurality of sensors are disposed side by side along a longer side of the predetermined surface.

3. The sensing device according to claim 1, wherein
each of the plurality of sensors has a rectangular shape, and
the plurality of sensors are disposed to have longer sides being substantially parallel to a shorter side of the predetermined surface.

4. The sensing device according to claim 1, wherein when adjacent sensors of the plurality of sensors sense any objects simultaneously, the determiner determines that the sensed objects are identical.

5. The sensing device according to claim 1, wherein the determiner determines in what proportion an object occupies an interior of the storage unit, based on the sensing results.

6. The sensing device according to claim 1, wherein at least one of the determiner and each of the plurality of sensors operates in response to closing of a door of the storage unit.

7. A sensing system comprising:
the sensing device according to claim 1; and
a display device that displays the determination result of the sensing device.
